(19) United States
(12) Patent Application Publication
(10) Pub. No.: US 2013/0068385 A1
(43) Pub. Date: Mar. 21, 2013

(54) Automatic Facility and Automatic Method for Decorating Items made of Rough or Refined Glass or of Plastic with Raised Patterns

(71) Applicants: Marcel Auger, Vatierville (FR); Regis Binet, Saint Germain Sur Bresle (FR); Johan Benoit, Beauchamps (FR)

(72) Inventors: Marcel Auger, Vatierville (FR); Regis Binet, Saint Germain Sur Bresle (FR); Johan Benoit, Beauchamps (FR)

(73) Assignee: POCHET DU COURVAL, Paris (FR)

(21) Appl. No.: 13/638,247

(22) PCT Filed: Mar. 29, 2011
(86) PCT No.: PCT/FR2011/050681

§ 371 Date: Dec. 4, 2012

(30) Foreign Application Priority Data
Mar. 31, 2010 (FR) 10 52395

(51) Int. Cl. C03C 27/00; B32B 38/00

(52) U.S. Cl. CPC C03C 27/00; B32B 38/145
USPC 156/273.5; 156/379.8

(57) ABSTRACT

The present invention provides an automatic facility for decorating items made of rough or refined glass or of plastic with raised patterns including a carrier for continuously moving the items between a station for loading the items onto the carrier, a station for screen-printing a decoration onto each item with UV ink, a station for ultraviolet pre-polymerization of the ink of the decoration, the ink remaining slightly tacky on the surface, a station applying a paper film using heat by adhering the paper film onto the ink of the decoration and a station for unloading the items towards a tunnel for the final ultraviolet polymerization of the decoration. A method is also provided.

The present invention relates to an automatic facility and automatic method for decorating items made of rough or refined glass or of plastic with raised patterns.

### BACKGROUND

In the field of perfumery or cosmetics, it is common to produce a decoration with raised patterns and giving a brilliant metal aspect of the gold or silver type, on items made of rough or refined glass, such as for example perfume flasks, or on plastic material items, The items generally used may be of different shapes, such as for example round, flat, oval or with any other shape.

Up to now, in order to produce this type of decorations on glass or plastic material items, these items are first of all manually placed by an operator in a screen-printing machine which deposits on each item according to a pre-determined line, a sublayer from a two-component organic ink.

Next, the items are deposited by an operator one after the other on a conveyor for transferring these items into a drying tunnel where they undergo pre-polymerization, allowing the ink to be sufficiently dried, while leaving it slightly tacky at the surface. The time for passing items into the drying tunnel is rather long, of the order of 15 to 20 minutes.

The items are deposited by an operator at the outlet of the tunnel in a hot marking machine in order to ensure the transfer of a paper film by adherization on the ink deposited beforehand on each item. The paper film is only deposited on the screen-printed patterns.

The items thereby covered with a decoration with a metal raised pattern for example looking like letters or stuck patterns, are then deposited in a final package.

The sequence of these operations with this type of installation takes a long time which causes low production throughput rate and the multiple handling operations cause significant risks of degradation.

Further, the temperature in the drying tunnel is a significant parameter requiring a very narrow range of acceptable temperatures and that a practically constant temperature be maintained and is difficult to obtain because of the air streams and of the control of the heating elements of the oven of the drying tunnel. The items baked outside this range are defective.

### SUMMARY OF THE INVENTION

An object of the present invention provides an automatic installation for decorating glass or plastic items with raised patterns, which allows an increase in the production throughput rates, while reducing the scrap rate and obtaining a more qualitative and covered decoration on the items.

Therefore the present invention provides an automatic installation for decorating rough or refined glass or plastic material items with raised patterns, characterized in that it comprises a carrier for continuously displacing the items between different stations including:
a station for loading the items on said carrier,
a station for laying by screen printing a decoration on each item by means of UV ink,
a station for ultraviolet pre-polymerization of the ink of the decoration, said ink remaining slightly tacky at the surface,
a station for hot laying a paper film by adherization on the ink of said decoration of each item; and
a station for discharging each item towards a tunnel for final ultraviolet polymerization of said decoration.

According to other features of the invention, the invention may include:
the displacement carrier comprises a rotationally displaceable table or a conveyor belt,
the loading station includes a dust removal and/or decontamination and/or surface treatment means,
the polymerization installation comprises at least one lamp of the ultraviolet type or light-emitting diodes of the ultraviolet type,
the exposure time of each item in the pre-polymerization station is about one second and at a distance of said at least one lamp or said diodes, comprised between about 5 and 10 centimeters, and
the exposure time of each item in the polymerization tunnel is comprised between about 30 and 45 seconds.

The present invention also provides an automatic method for decorating rough or refined glass or plastic material items with raised patterns characterized in that after having deposited the items on its carrier, these items are continuously displaced and:
a decoration is screen-printed on each item by means of a UV ink,
ultraviolet pre-polymerization of the ink of the decoration is carried out, said ink remaining slightly tacky at the surface,
a paper film is hot-laid by adherization on the ink of said decoration of each item, and
final ultraviolet polymerization of said decoration is carried out.

The invention will be better understood upon reading the description which follows, given as an example and made with reference to the single appended figure which illustrates a schematic top view of a decoration installation, according to the invention.

### BRIEF DESCRIPTION OF THE FIGURE

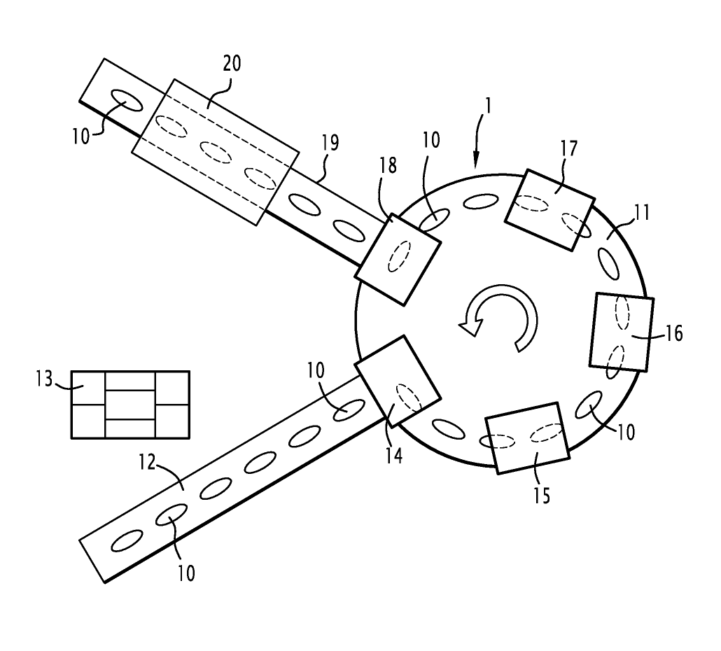

In FIG. 1, an installation is schematically illustrated, designated by the general reference 1 and intended to automatically produce on rough or refined glass or plastic material items, a decoration with raised patterns and giving a brilliant metal aspect of the gold or silver type for example.

### DETAILED DESCRIPTION

The items 10 are for example formed with glass or plastic flasks of any shapes.

As illustrated in the FIGURE, the installation comprises a carrier 11 for continuously displacing the items 10 between different stations, notably treatment stations, in order to obtain at the exit, items 10 including a decoration with raised patterns. In the exemplary embodiment illustrated in this FIGURE, the carrier 11 is formed by a rotationally displaceable table, such as for example a carousel with several treatment stations.

According to an alternative, the carrier 11 may for example be formed with a conveyor belt or by any other system for continuously displacing the items 10.

In the following, the carrier 11 will be designated by the term of “carousel” in order to make understanding easier.

The installation includes an element 12 for transporting the items 10 between a storage point 13 and the carousel 11. This transport element 12 is formed with a conveyor, for example an endless conveyor belt or any other suitable system of a known type.

The rough or refined glass or plastic material items 10 are for example transferred with at least one manipulator arm, not shown, from a conveyor 12 into a station 14 for loading these items on the carousel 11.

According to a preferential embodiment, the loading station 14 is equipped with an assembly for treating each item 10, of a known type, for example including dust removal means and/or decontamination means, for example by ionized air and/or surface treatment means for example by a plasma.

Following the loading station 14, the carousel 11 includes a station 15 for screen-printing a sublayer forming a decoration on each item 10 by means of UV ink. The screen-printing of a UV ink uses known means and notably a polyester web screen, for example in nylon, and a squeegee. The UV inks inter alia have the advantage of not drying in the meshes of the screen.

The carousel 11 is also provided with a pre-polymerization station 16 positioned after the laying station 15 relatively to the displacement direction of this carousel 11. With this pre-polymerization operation, it is possible to sufficiently dry the ink deposited beforehand on each item 10, while leaving it slightly tacky at the surface. For this, the pre-polymerization station 16 comprises at least one lamp of the ultraviolet type or light-emitting diodes also of the ultraviolet type. The exposure time of each item 10 in this pre-polymerization station 16 is very short and of about one second and each item 10 is placed at a distance from said at least one lamp or said diodes, comprised between about 5 and 10 centimeters. Consequently, partial flash drying of the UV ink by means of an ultraviolet source is very fast and it is thereby possible to obtain a slightly tacky surface of the ink.

According to an alternative, several pre-polymerization stations 16 may be placed in series on the carousel 11 one following the other or in parallel.

Thus, at the exit of the pre-polymerization station 16, each item 10 includes, according to a pre-determined line, an ink sub-layer.

The pre-decorated items 10 are transported by the carousel 11 into a station 17 for hot laying a paper film by adherization on the ink deposited beforehand.

The hot marking station 17 is of a known type and for example includes a roller or a plate coated with a silicone, heated to a temperature of the order of about 200° C. The marking station 17 ensures transfer of a paper film by adherization on the ink deposited beforehand on each item 10. The paper film is only deposited on the screen-printed patterns by which it is possible to obtain a decoration with metal raised patterns for example looking like letters or patterns of diverse shapes.

The thereby obtained decoration with raised patterns for example has a brilliant metal aspect of the gold or silver type.

After the hot marking operation in station 17, the items 10 are continuously displaced towards a station for unloading these items where a manipulator arm, deposits these entirely decorated items on a conveying element 19, such as a conveyor belt, of a known type.

The items 10 continuously pass into a final ultraviolet polymerization tunnel 20, for the decoration deposited beforehand on each of these items. The exposure time of each item is from about 30 to 45 seconds.

The items 10 are then inspected and packaged.

The installation according to the invention gives the possibility of obtaining a high production throughput rate because of a shorter cycle time than in the installations used up to now, while reducing the scrap rate because of less sensitivity to changes in temperature.

Further, the obtained items may have a more vivid decoration and by using a very rapidly pre-polymerized UV ink, it may be possible to transfer the hot marking film immediately after that, which considerably limits the decoration cycle for the items.

Finally, with the final ultraviolet polymerization it may be possible to obtain better strength of the decoration on the items.

What is claimed is:

1-7. (canceled)

8. An automatic installation for decorating rough or refined glass or plastic material items with raised patterns, including a carrier for continuously displacing the items between different stations comprising:
a loading station for loading the items on the carrier;
a screen printing station for screen-printing a decoration on each item by means of a UV ink;
a station for ultraviolet pre-polymerization of the ink of the decoration, the ink remaining slightly tacky at the surface;
a station for hot laying a paper film by adherization on the ink of the decoration of each item, and
a station for unloading each item to a polymerization tunnel for final ultraviolet polymerization of said decoration.

9. The installation according to claim 8, wherein the displacement carrier is a rotationally displaceable table or a conveyor belt.

10. The installation according to claim 8, wherein the loading station includes a dust removal device or a decontamination device or a surface treatment device.

11. The installation according to claim 8, wherein the pre-polymerization station includes at least one ultraviolet lamp or ultraviolet light-emitting diodes.

12. The installation according to claim 11, wherein the exposure time of each item in the pre-polymerization station is about one second and each item is at a distance between 5 and 10 centimeters from the at least one lamp or the light-emitting diodes.

13. The installation according to claim 8, wherein the exposure time of each item in the polymerization tunnel is between 30 and 45 seconds.

14. An automatic method for decorating rough or refined glass or plastic material items with raised patterns, the items being deposited on a carrier and continuously displaced, comprising the steps of:
screen printing a decoration on each item by means of UV ink;
carrying out ultraviolet pre-polymerization of the ink of the decoration, the ink remaining slightly tacky at a surface;
hot laying a paper film by adherization on the ink of the decoration of each item, and
carrying out a final polymerization of the decoration with ultraviolet radiation.

15. The installation according to claim 9 wherein the rotationally displaceable table is a carousel.

16. The installation according to claim 10 wherein the decontamination device includes ionized air.

17. The installation according to claim 10 wherein the surface treatment includes plasma.

18. The installation according to claim 8 further comprising a further station for ultraviolet pre-polymerization of the ink of the decoration.
